(19) United States
(12) Patent Application Publication
(10) Pub. No.: US 2008/0257127 A1
(43) Pub. Date: Oct. 23, 2008

(54) SAW BLADE

(75) Inventor: Karthik Krishna, Canton, OH (US)

Correspondence Address: HAHN LOESER & PARKS, LLP, One GOJO Plaza, Suite 300, AKRON, OH, 44311-1076, US

(73) Assignee: THE M. K. MORSE COMPANY, Canton, OH (US)

(21) Appl. No.: 11/736,133

(22) Filed: Apr. 17, 2007

(51) Int. Cl. B23D 35/00

(52) U.S. Cl. 83/676

(57) ABSTRACT

A rotary saw blade is provided that has improved metal cutting performance by reducing vibration and producing less noise than typical rotary saw blades. The saw blade comprises a “gullet-less” design that helps reduce the generation of noise caused by the aerodynamic effects of the rotating saw blade on the ambient air. On embodiment of the saw blade uses a grouping of tip placement about the periphery of the saw blade to further reduce the generation of vibration during cutting operations.

### TECHNICAL FIELD

The invention relates generally to saw blades and, more particularly, to a rotary saw blade having improved metal cutting performance by reducing vibration and producing less noise than typical rotary saw blades.

### BACKGROUND OF THE INVENTION

Rotary saw blades typically consist of a plurality of teeth extending generally radially from the periphery of a round metal plate. The teeth are often formed by carbide tips attached to the periphery of the round metal plate. A gullet opens in front of and extends radially inwardly from each tip to provide a space in which chips can move away from the cutting edge of the tip as they are cut away from the workpiece. A hole is formed in the center of the plate to attach the blade to the arbor of a rotary tool such as a portable, hand-held circular saw, or a fixed table or radial saws, or other like saws such that the blade can be rotated by the rotary tool.

Noise is a serious problem with using rotary saw blades. Noise levels generated by circular saws in operation have been reported to vary from 80 dB of 220 dB. The noise problem is not limited to the cutting operation as that, even when idling, circular saws can produce noise levels up to 95 dB. Circular saw noise comprises two main components: idling noise and cutting noise.

Idling Noise. Even when not cutting, the high speed rotation of the saw blade can still generate a significant level of noise. A 14-inch diameter saw blade rotating at an operating speed of 1800 rpm can have a noise output as high as 90 to 110 dB. The reason is that the rotation of a circular saw blade generates aerodynamic noise by reason of its shape and, in particular, the shape of the gullets between the teeth of the saw blade. As previously mentioned, the gullet opens in front of and radially inwardly from each cutting edge on a blade, to provide a space in which chips can move away from the cutting edge of the tooth as they are cut away from the workpiece. The gullet is formed at an adequate size to accommodate the flow of chips that develops at high cutting feed rates, and shaped as to encourage chips to move away from the cutting edge in a direction radially inwardly relative to the blade. As a saw blade rotates, the saw blade imparts a combined radially outward and circumferential flow to the layer of air adjacent to it. The shape of the gulleted blade periphery causes the air flow to assume a rather complex pattern marked by severe turbulence around radially outer portions of the blade, particularly across the gullets and around the projecting teeth and tooth tips. Such turbulence involves oscillating reversals of air flow which occur at relatively high sonic frequencies, and the blade thus propagates aerodynamic noise as a result of its action upon the ambient air. The aerodynamic effect can also cause the blade to vibrate and generate additional noise.

Cutting noise. Cutting noise results from the vibration of the saw blade itself and vibration of the workpiece (also referred to as workpiece noise), both of which are excited by tooth impact. When cutting, especially with the blade having evenly spaced teeth, the teeth hit the workpiece at fixed intervals and develop harmonics which can result in significant vibration and noise. Excessive vibration can cause a rough surface on the edges of the cut and can result in the workpiece jamming in the saw. Workpiece noise is a particular problem when cutting metal or plastics as these materials are particularly susceptible to vibration.

At least one prior art saw blade uses sandwiched laminations of vibration damping material. These saw blades have provided only small improvements in vibration and noise output reduction during cutting operations. Other prior art attempts to reduce vibration and noise have involved interrupting or varying tooth and gullet configurations arranged about the periphery of the saw blade in relatively complex patterns which tend to be difficult and/or expensive to manufacture. While apparent improvements have been made with these techniques for reducing vibration and noise during cutting operations, these features have had little to no effect on the reduction of noise when the blade is not cutting.

### SUMMARY OF THE INVENTION

At least one advantage over the prior art is provided by an embodiment of a saw blade comprising: a generally circular, plate saw body having a uniform thickness; and a plurality of groups of tips spaced about an outer periphery of the saw body and attached to the saw body; the tips of each group being spaced at a generally equivalent circumferential pitch about the periphery of the circular saw body; each group of tips being separated by a circumferential distance greater than the circumferential pitch between adjacent tips of each group; the outer periphery of the saw body formed such that the outer periphery does not extend radially inward of the tips other than at the attachment location of the tip and the saw body surface.

At least one advantage over the prior art is also provided by an embodiment of a saw blade comprising: a generally circular, plate saw body having a uniform thickness; and a plurality of groups of tips spaced about an outer periphery of the saw body and attached to the saw body; the tips of each group being spaced at a generally equivalent circumferential pitch about the periphery of the circular saw body; each group of tips being separated by a circumferential distance greater than the circumferential pitch between adjacent tips of each group; the outer periphery of the saw body formed such that the outer periphery extends radially outward from a bottom attachment location of a each tip, circumferentially toward the back attachment location of the preceding tip; wherein the tips are positioned in a cutting sequence within each group of tips that alternates between a left corner beveled tip and a right corner beveled tip and ends with a flat top tip.

At least one advantage over the prior art is also provided by an embodiment of a saw blade comprising: a generally circular saw body having a generally uniform thickness; a plurality of tips spaced about an outer periphery of the circular saw body and attached to the saw body; the outer periphery of the saw body formed such that the outer periphery does not extend radially inward of the tips other than at the attachment location of the tip and the saw body surface.

These and other advantages will be apparent upon a review of the drawings and detailed description of the invention.

### BRIEF DESCRIPTION OF THE DRAWINGS

Embodiments of the invention will now be described in further detail with reference to the accompanying drawings, in which:

FIG. 1 is a side view of a typical prior art tipped saw blade;

FIG. 2 is a front view of typical prior art tips including a flat top, a flat top with a right side corner removed, and a flat top with a left side corner removed;

FIG. 3 is a partial side view of a saw blade in accordance with the present invention;

FIG. 4 is a schematic view showing the chip load distribution of the saw blade of FIG. 3;

FIG. 5 is a partial side view of another embodiment of the saw blade of the invention having a sequence of alternating tips and a modified tip distribution about the periphery;

FIG. 6 is a partial top view of the saw blade of FIG. 5 showing the saw blade body width and the width of the tips;

FIG. 7 is a schematic view showing the chip load distribution of the saw blade of FIG. 5;

FIG. 8 is a photo of a cut of a metal stud made by a typical prior art tipped saw blade; and

FIG. 9 is a photo of a cut of a metal stud made by the saw blade of FIG. 5.

### DETAILED DESCRIPTION OF THE DRAWINGS

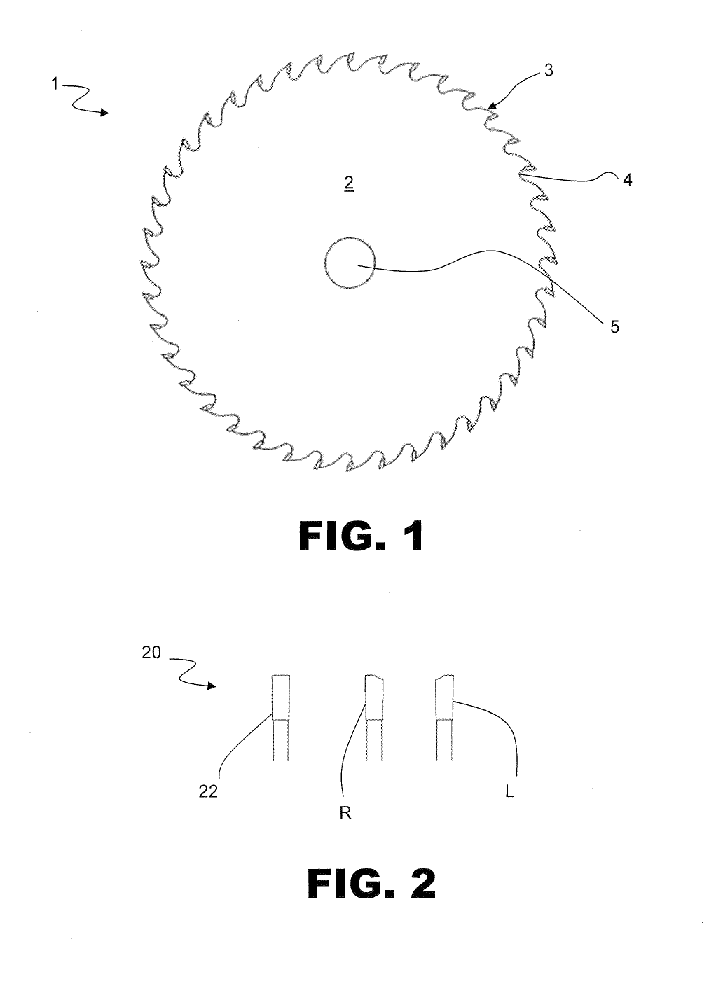

A typical prior art saw blade 1 is shown in FIG. 1. The saw blade 1 consists of a circular metal body 2 having a plurality of carbide tip teeth 3 attached in fixed circumferential intervals about the periphery of the body 2 and at a fixed radial distance from the center of the body 2. A gullet 4 is shown between each of the teeth 3 about the periphery of the body 2. Each gullet 4 opens in front of each corresponding tooth 3 and extends radially inwardly from the bottom of the cutting tip tooth 3 before curving back upward toward the top of the preceding adjacent tooth 3. An aperture 5 is formed through the center of the body for attaching the saw blade 1 to a rotary saw, not shown.

Referring now to FIG. 2, several different types of prior art tips 20 are shown. The tips 20 are typically made of carbide which is an alloy composed of Cobalt and Tungsten. Carbide is well known to provide longer lasting tips, sharper cutting edges, and greater impact resistance. The left most tip is generally referred to as a flat top tip 22 or square top tip. The next tip is a flat top tip having the right corner of the tip removed and is referred to herein as a right corner bevel tip R. The tip on the right is a flat top tip having the left corner of the tip removed and is referred to herein as a left corner bevel tip L. Additional tip configurations are also well known, although not specifically shown herein, and it is contemplated that these additional tip configurations could be used in embodiments of the invention described below.

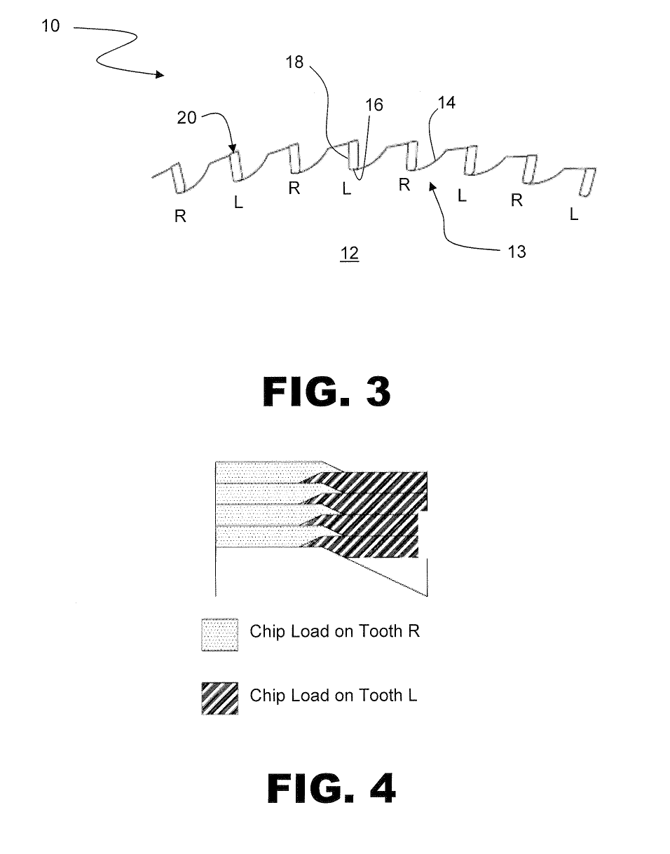

A first embodiment of the saw blade 10 of present invention is shown in FIG. 3. Saw blade 10 comprises a generally circular plate steel saw body 12 having a generally uniform thickness kept to tight tolerances. The body 12 is the backbone of the blade and is typically made from a high carbon, chrome, nickel and special moly-alloy steel. A plurality of tips 20 are spaced about an outer periphery 13 of the circular saw body 12 and attached to the saw body 12 typically by a brazing process along a bottom 16 of the tip and a back 18 of the tip 20. The saw blade 10 of the present invention is a “gullet-less” configuration in that the periphery 13 of the saw body 12 is formed such that the periphery 13 does not extend radially inward of the tips 20 other than at the attachment location of the tip 20 and the saw body 12. (It is recognized that the height of the tips technically create a gullet—however—in the saw blade of the present invention the periphery of the saw blade does net extend radially inward of the bottom 16 of the tip 20—as in the case of typical gullets). The shoulder 14 is the part of the blade body 12 directly behind each tip 20 which provides support for the tip 20. The “gullet-less” design of the present invention is better suited to cutting metal than cutting wood.

In the embodiment shown in FIG. 3, the tips 20 are ground to have either a right corner bevel R or a left corner bevel L in an alternating sequence about the periphery 13 of the blade body 12. The alternating sequence produces a chip load distribution as shown in FIG. 4 wherein each tip 20 has the same load distribution.

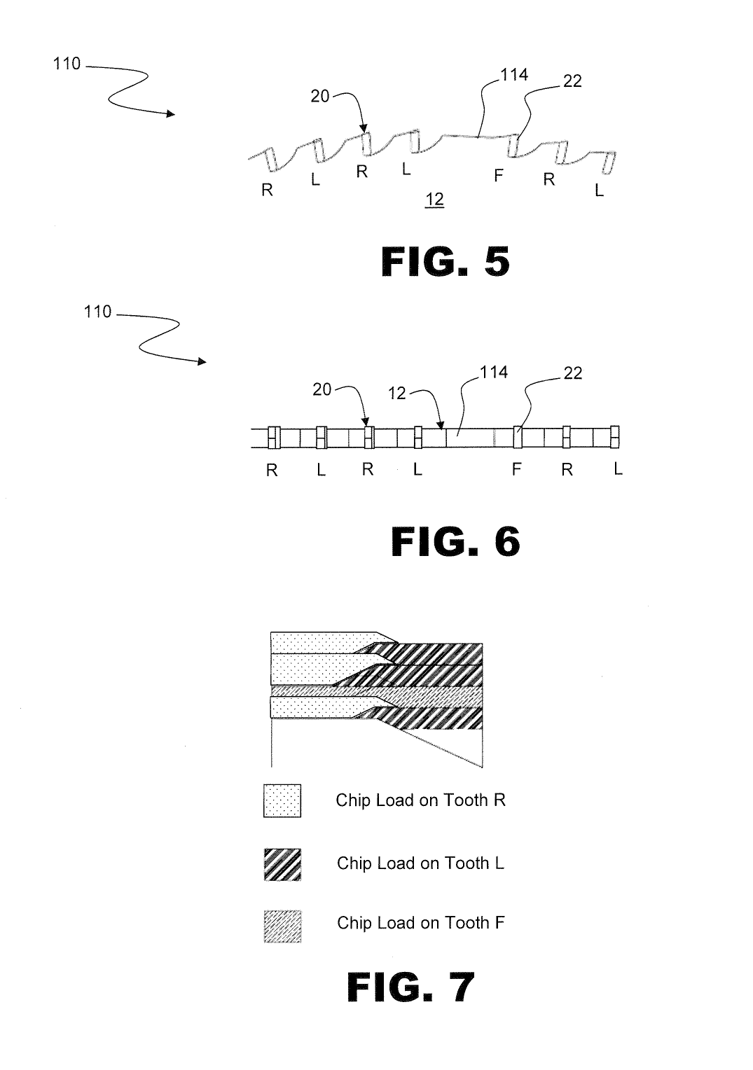

While the saw blade 10 of FIG. 3 produces less noise in operation due to the “gullet-less” design, the saw blade 10 may still be susceptible to vibration during cutting due to the evenly spaced tips 20 and the development of harmonics as previously discussed. Referring now to another embodiment of the invention as shown in FIG. 5, a saw blade 110 is shown having variations in the tip spacing about the periphery of the blade body 12. As shown in FIG. 6, the width of the beveled tips 20 and the flat top tip 22 are wider than the blade body 12. Referring again to FIG. 5, saw blade 110 is similar to the previous embodiment except that at least one tip 20 is removed and the shoulder 114 extended to span the gap between the tips 20. In addition, a flat top tip 22 is placed on the front of the extended shoulder 114, as shown in FIGS. 5 and 6. The positioning of the flat top tip 22 in this manner helps even out the chip load distribution as best shown in FIG. 7. As shown, the flat top tip 22 removes the material that a left corner bevel L would have removed plus an additional amount of material beyond that removed by the preceding right corner bevel R. After the extended shoulder 114, the next tip 20 is a left corner bevel tip L that is required to cut only a small portion larger than if it were not adjacent the extended shoulder 114. The next tip 20 in the cutting sequence is a right corner bevel tip R that is also required to cut only a small portion larger than the other right corner bevel tips R shown in the chip load distribution. Accordingly, the use of the flat top tip 22 helps more evenly distribute the extra chip load caused by the extended circumferential distance between tips at the extended shoulder 114.

The removal of the at least one tip 20 also results in less vibration by providing a variance in the timing of the tips 20 striking the workpiece and thus preventing the development of vibrational harmonics during cutting operations. It is contemplated that more than one tip 20 can be removed to help prevent the development of vibrational harmonics during cutting operations. For example, in one embodiment, a fourteen-inch saw blade typically having 80 teeth equally spaced about the periphery of the saw blade can be modified by removing every tenth tip 20 (eight equally spaced teeth removed). This results in the tips of the saw blade being in groups 28 of equally spaced tips 20, each group 28 being separated from each other by a “null” space. In another embodiment, the removed tip could be every eighth tip (ten equally spaced teeth removed) about the periphery of the saw blade (not shown). It is also contemplated that the removal of the tips 20 does not need to be evenly distributed about the periphery of the saw blade. For example, the removal of every eighth tip can be interrupted by the removal of every tenth tip such that nine alternatingly spaced tips (8, 10, 8, 10 . . . ) are removed about the saw blade (not shown). These examples provide other variations to help prevent the development of vibrational harmonics during cutting operations. Regardless of the sequence, the tip position in front of the extended shoulder is a flat top tip 22 when the remaining teeth are alternating right corner bevel tips and left corner bevel tips. The next tip 20 after the extended shoulder 114 is also shown to be the opposite in the alternating sequence of the tip preceding the flat top tip 22. These embodiments are provided as examples only and are not intended to limit the invention to the sequence or types of tips shown or the positioning of the removed teeth about the periphery of the saw blade.

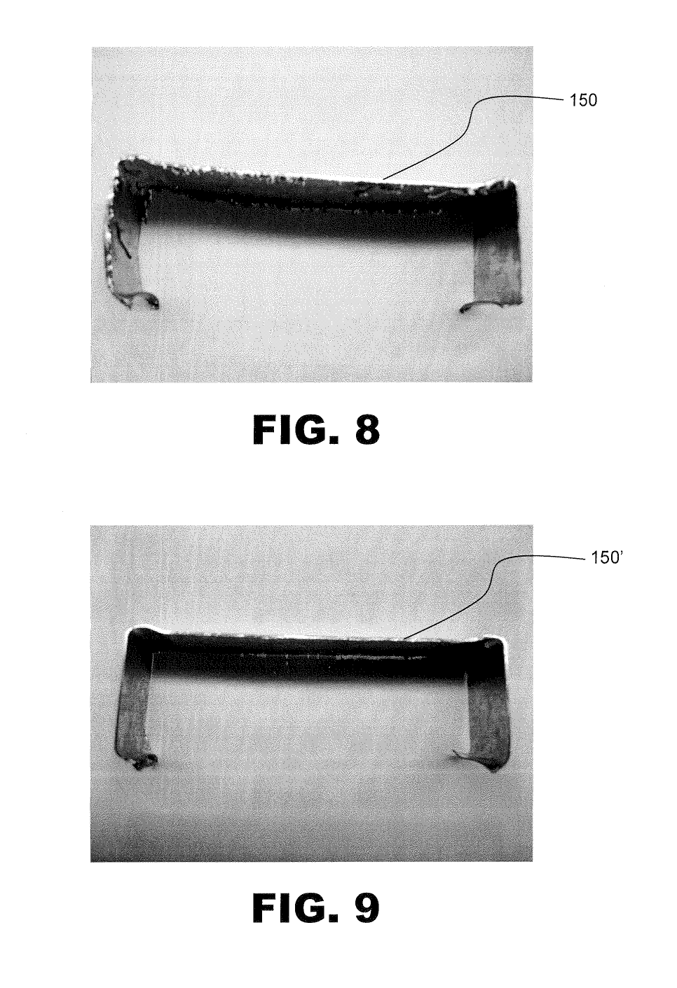

The reduction in the noise and vibration that results from the saw blade as shown in FIG. 5 is directly related to improvement in the surface finish provided by the saw blade. Referring now to FIG. 8, a picture of a 25 gauge steel stud 150 is shown in cross-section as cut by a prior art saw blade of the type shown in FIG. 1 after the saw blade had made 100 cuts of similar 25 gauge steel studs. The picture shows that the stud 150 has been dimensionally distorted and that burrs developed during the cut that result in a jagged edge for the cut surface. In contrast, as shown in FIG. 9, a picture of a 25 gauge steel stud 150′ is shown in cross-section as cut by a saw blade in accordance with an embodiment of the present invention as shown in FIG. 5. As with the prior art blade, the saw blade that made the cut shown had previously made 100 cuts of similar 25 gauge steel studs. The surface finish of the cut edge does not have burrs and is relatively smooth. No dimensional distortion of the steel stud 150′ is apparent. The reduced vibration also allows the operator to cut the material faster, resulting in lower cycle times for each cut.

While this invention has been described with reference to preferred embodiments thereof, it shall be understood that such description is by way of illustration and not by way of limitation. Accordingly, the scope and content of the present invention are to be defined only by the terms of the appended claims.

1. A circular saw blade comprising:
a generally circular, plate saw body having a uniform thickness; and
a plurality of groups of tips spaced about an outer periphery of the saw body and attached to the saw body;
the tips of each group being spaced at a generally equivalent circumferential pitch about the periphery of the circular saw body;
each group of tips being separated by a circumferential distance greater than the circumferential pitch between adjacent tips of each group;
the outer periphery of the saw body formed such that the outer periphery does not extend radially inward of the tips other than at the attachment location of the tip and the saw body surface.

2. The circular saw blade of claim 1, wherein the cutting sequence of each group of tips alternates between a left corner beveled tip and a right corner beveled tip and ends with a flat top tip.

3. The circular saw blade of claim 1, wherein the groups of tips are symmetrically spaced about the outer periphery of the saw body.

4. The circular saw blade of claim 1, wherein the groups of tips are asymmetrically spaced about the outer periphery of the saw body.

5. The circular saw blade of claim 1, wherein the saw body is made at least in part of steel.

6. The circular saw blade of claim 1, wherein the tips are made of carbide.

7. A circular saw blade comprising:
a generally circular, plate saw body having a uniform thickness; and
a plurality of groups of tips spaced about an outer periphery of the saw body and attached to the saw body;
the tips of each group being spaced at a generally equivalent circumferential pitch about the periphery of the circular saw body;
each group of tips being separated by a circumferential distance greater than the circumferential pitch between adjacent tips of each group;
the outer periphery of the saw body formed such that the outer periphery extends radially outward from a bottom attachment location of a each tip, circumferentially toward the back attachment location of the preceding tip.
wherein the tips are positioned in a cutting sequence within each group of tips that alternates between a left corner beveled tip and a right corner beveled tip and ends with a flat top tip.

8. The circular saw blade of claim 7, wherein the groups of tips are symmetrically spaced about the outer periphery of the saw body.

9. The circular saw blade of claim 7, wherein the groups of tips are asymmetrically spaced about the outer periphery of the saw body.

10. The circular saw blade of claim 7, wherein the saw body is made at least in part of steel.

11. The circular saw blade of claim 7, wherein the tips are made of carbide.

12. A saw blade comprising:
a generally circular saw body having a generally uniform thickness;
a plurality of tips spaced about an outer periphery of the circular saw body and attached to the saw body;
the outer periphery of the saw body formed such that the outer periphery does not extend radially inward of the tips other than at the attachment location of the tip and the saw body surface.

13. The circular saw blade of claim 12, wherein the plurality of tips comprises a plurality of right bevel corner tips and a plurality of left corner bevel tips.

14. The circular saw blade of claim 13, wherein the plurality of right bevel corner tips and the plurality of left corner bevel tips are positioned about the periphery of the circular saw body in an alternating sequence.

15. The circular saw blade of claim 12, wherein the tips are spaced at a generally equivalent angular pitch about the periphery of the circular saw body.

16. The circular saw blade of claim 12, wherein the tips are spaced such that the angular pitch of at least two adjacent tips is larger than the angular pitch of at least two other adjacent tips about the periphery of the circular saw body.

17. The circular saw blade of claim 16, wherein the plurality of tips comprises a plurality of right bevel corner tips and a plurality of left corner bevel tips and at least one flat top tip, wherein the plurality of right bevel corner tips and the plurality of left corner bevel tips are positioned about the periphery of the circular saw body in an alternating sequence, wherein the at least one flat top tip is interspersed into the sequence at a leading rotational location of the at least two adjacent tips having the larger angular pitch.
